(19) United States
(12) Patent Application Publication
(10) Pub. No.: US 2025/0369881 A1
(43) Pub. Date: Dec. 4, 2025

(54) OPTICAL PHASED ARRAY SYSTEM WITH CLOSED-LOOP COMPENSATION OF ATMOSPHERIC TURBULENCE AND NOISE EFFECTS

(71) Applicant: RAFAEL ADVANCED DEFENSE SYSTEMS LTD., Haifa (IL)

(72) Inventors: Daniel GOLUBCHIK, Kiryat Bialik (IL); David SHWA, Kfar Tavor (IL)

(21) Appl. No.: 18/873,810

(22) PCT Filed: Mar. 27, 2023
(86) PCT No.: PCT/IB2023/053008

§ 371 Date: Dec. 11, 2024

(30) Foreign Application Priority Data
Jul. 13, 2022 (IL) 294735

(51) Int. Cl. G01N 21/59; G02B 27/14

(52) U.S. Cl. CPC G01N 21/59; G01N 2201/06113; G02B 27/141

(57) ABSTRACT

A system for illuminating a target in the presence of atmospheric turbulence includes a coherent beam combining (CBC) subsystem, an atmospheric wave-front sensor (AWS) subsystem, a multi-channel photo-detector (MCPD) subsystem, an auxiliary light source, and a receiving optical aperture. The CBC subsystem forms a multiplicity of CBC sub-beams and an reference beam, all of which fall in a wavelength band that is different from that of the auxiliary light source. The auxiliary light source may be a laser or a portion of the solar spectrum of the Sun. An AWS controller provides closed-loop compensation of atmospheric turbulence for low power auxiliary reflection and reference beams. A MCPD controller provides closed-loop compensation of high-frequency laser noise and transfers the wavefront correction from the reference to the high power CBC laser. The frequency of the MCPD controller is at least an order of magnitude greater than the bandwidth of the AWS controller.

### FIELD OF THE INVENTION

The invention relates to Optical Phased Array (OPA) systems, and specifically to closed-loop compensation of atmospheric turbulence and noise effects in such systems.

### BACKGROUND OF THE INVENTION

An Optical Phased Array (OPA) system, which is designed to illuminate a target with a high-power free space laser, must overcome limitations posed by wave-front distortions caused by propagation through a turbulent atmosphere.

The mitigation of atmospheric turbulence has traditionally followed one of two approaches. The first involves using a laser, a deformable mirror (DM), and a wave-front sensor (WFS). The WFS measures residual aberrations in light reflected from the target and sends closed-loop control signals to the DM. This approach is difficult to implement in practice because of nonlinear effects which place a limit on the power of solid-state lasers, and also because of the difficulty of manufacturing a DM that can sustain the heat load of a high-powered laser while operating at a high mechanical bandwidth.

A second approach, which overcomes the limitation of laser power scalability, is to illuminate a target with a multiplicity of partially coherent laser sub-beams formed by a coherent beam combining (CBC) subsystem. The optical phases of the sub-beams are adjusted so as to add coherently at the surface of the target. However, the effects of laser noise and of atmospheric turbulence perturb the relative phases between the sub-beams and must continually be compensated in order to maintain phase coherence on the target.

U.S. Pat. No. 7,343,098, to D. R. Gerwe et al., issued on Mar. 11, 2008, and entitled “Fiber Optic Phased Array and Associated Method for Accommodating Atmospheric Perturbations with Phase and Amplitude Control”, provides a fiber optic phased array and control method for controllably adjusting the phase and amplitude of the optical signals emitted by a plurality of fiber optic amplifiers to compensate for atmospheric turbulence. The disclosed configuration uses open-loop control, which is adversely effected by errors in calibration and actuation.

US patent application publication number US 2021/0294109 to D. Golubchik et al., published on Sep. 23, 2021, and entitled “Coherent Beam Combination (CBC) Systems and Methods” discloses a CBC system which includes an array of beams sources generating coherent beams directed towards a target, and interferometric techniques referred to as Target-in-the-Loop Interferometry (TILI). However, the TILI approach is typically limited in the achievable target range and is sensitive to fluctuations in target reflectivity.

### SUMMARY OF INVENTION

The invention provides closed-loop compensation of both atmospheric turbulence and high-frequency laser noise, thereby enabling a high-power OPA system to illuminate a target at long range with multiple CBC sub-beams. The OPA system includes electro-optical modulators for wave-front compensation, as well as a practical deformable mirror that need not be configured to work with high-power lasers.

According to one aspect of the presently disclosed subject matter, there is provided an optical phased array (OPA) system for illuminating a target in the presence of atmospheric turbulence including a coherent beam combining (CBC) subsystem forming a multiplicity of at least partially coherent CBC sub-beams and a reference beam. The CBC sub-beams and the reference beam have a first band of optical wavelengths. The OPA system also includes a beam director for directing the CBC sub-beams to illuminate the target, an auxiliary light source to illuminate the target with light having a second band of optical wavelengths, a receiving optical aperture configured to receive a portion of light reflected from the target in the first and second bands of optical wavelengths, an atmospheric wave-front sensor (AWS) subsystem optically coupled to the receiving aperture and to the reference beam, and a multi-channel photo-detector (MCPD) subsystem optically coupled to the CBC sub-beams and to the reference beam. The AWS subsystem includes a closed-loop AWS controller for providing atmospheric turbulence compensation, and the MCPD subsystem includes a closed-loop MCPD controller for compensating phase noise effects in the CBC sub-beams and for transferring the atmospheric turbulence compensation from the reference beam into the CBC beam.

According to some aspects, a frequency of the MCPD controller is at least an order of magnitude greater than a bandwidth of the AWS controller.

According to some aspects, the OPA system further includes a CBC sub-beam phase compensator which is in communication with the MCPD controller.

According to some aspects, the MCPD subsystem includes an array of photo-detectors having at least one pixel for each of the CBC sub-beams.

According to some aspects, a bandwidth of the AWS controller is less than or equal to ten kilohertz.

According to some aspects, the reference beam is collimated.

According to some aspects, the reference beam overlaps with all of the CBC sub-beams at an incident surface of the MCPD subsystem.

According to some aspects, the reference beam undergoes a phase modulation which is different from that of the CBC sub-beams.

According to some aspects, the AWS subsystem comprises a deformable mirror (DM) and a DM actuator.

According to some aspects, a surface of the DM is segmented or continuous.

According to some aspects, the AWS subsystem includes a Shack-Hartmann sensor, a pyramid detector, or a phase diversity sensor.

According to some aspects, the AWS subsystem includes an optical filter which attenuates the light passing through the receiving optical aperture whose wavelength is outside the second band of optical wavelengths.

According to some aspects, the OPA system includes a dichroic beam-splitter.

According to some aspects, the auxiliary light source is a laser.

According to some aspects, the auxiliary light source is a solar spectrum of the Sun.

### BRIEF DESCRIPTION OF THE DRAWINGS

The invention is herein described, by way of example only, with reference to the accompanying drawings.

FIG. 1 is a schematic drawing of an exemplary OPA system, according to the invention.

FIG. 2 is a cross-sectional view of the overlap between the OPA reference beam and each of the CBS sub-beams, at an incident surface of a multi-channel photodetector (MCPD).

### DETAILED DESCRIPTION OF THE INVENTION

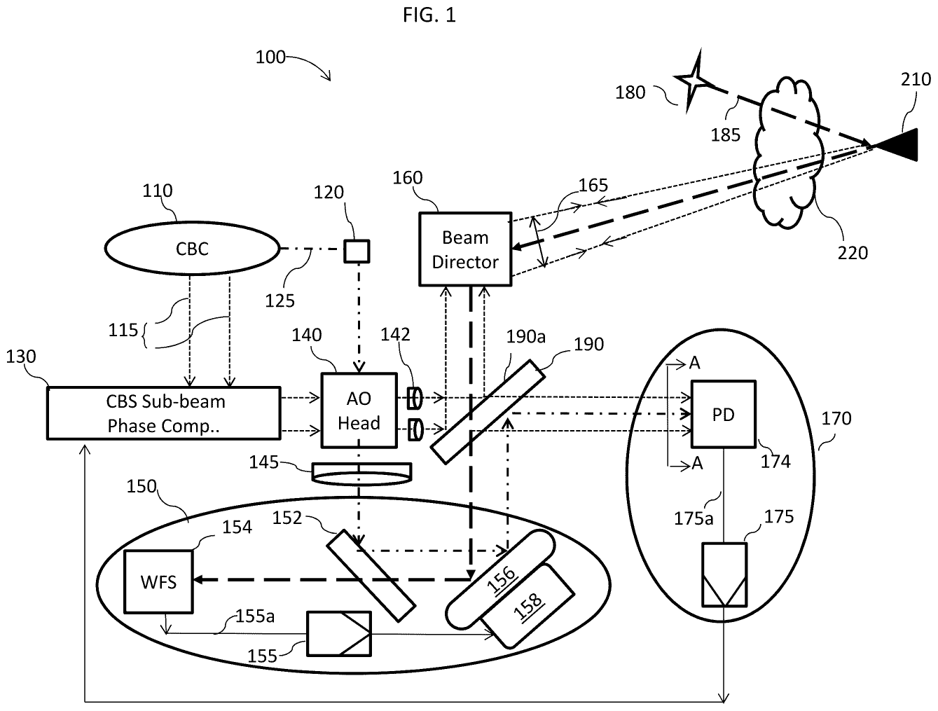

FIG. 1 shows a schematic drawing of an exemplary OPA system 100, according to the principles of the invention. CBC subsystem 110 generates a multiplicity of CBC sub-beams 115 indicated by dashed lines and an OPA reference beam 125 indicated by a dash-dot line. These beams are at least partially coherent and are typically generated by a fiber seed laser and a master oscillator power amplifier (MOPA) configuration, which is split into multiple CBC sub-beams. Although the sub-beams and the OPA reference beam are generated by the same seed laser, and consequently have a common central wavelength, denoted by λ₁, some relative phase noise is generally contributed by thermal variations and acoustic vibrations. By way of example, λ₁ may be equal to 1070 nanometers (nm) and the relative phase noise may have a bandwidth of up to 10 kilohertz (KHz).

An auxiliary beam 185 is generated by an illumination source 180, which may be a narrow-band laser source with a central wavelength, denoted by λ₂. In an alternative embodiment, the illumination source 180 may be a wide-band source, such as the solar spectrum of the Sun. In the latter case, the system 100 generally incorporates a band-pass filter, which selects a portion of the solar spectrum whose central wavelength is again denoted by λ₂.

Table 1 below explains the line symbols used in FIG. 1 for each of the three beam types: CBC sub-beams, OPA reference beam, and auxiliary beam.

TABLE 1

| | Wavelength | |
|---|---|---|
| Beam | Band | Line symbol |
| CBC sub-beams (115) | λ₁ | [symbol] |
| OPA reference beam (125) | λ₁ | [symbol] |
| Auxiliary beam (185) | λ₂ | [symbol] |

CBC sub-beam phase compensator 130 adjusts the relative optical phases of the CBC sub-beams 115 using feedback signals provided by a multi-channel photodetector (MCPD) subsystem 170. In some embodiments, an optical phase modulator 120 applies a phase modulation to the reference beam 125, which simplifies the subsequent extraction of relative phase data in the MCPD subsystem 170, by avoiding a need to compensate for amplitude fluctuations.

Adaptive optics (AO) head 140 converts the CBC sub-beams 115 and the OPA reference beam 125 into free-space optical beams. Each of the sub-beams 115 is collimated by collimator optics 142, and the reference beam 125 is collimated by a large-aperture collimator optic 145.

Auxiliary beam 185 illuminates the target 210, and a portion of beam 185 is reflected back towards aperture 165. The light from the receiver optical aperture 165 passes back through dichroic beam-splitter 190 and enters an turbulence correction system (TCS) subsystem 150. The latter processes the light in order to determine and correct the phase distortion caused by the atmospheric turbulence, as explained below.

The light received from aperture 165 is reflected by a deformable mirror (DM) 156, whose surface is controlled by a DM actuator 158. The DM surface may be continuous or may have discrete mirror segments. The DM-reflected light, at wavelength λ₂, passes through a beam-splitter 152 and into a wavefront subsystem (WFS) 154. The WFS 154 may be implemented, for example, by a Shack-Hartmann sensor, a pyramid detector, or a phase diversity sensor. In this exemplary embodiment, the beam-splitter 152 is a dichroic beam-splitter which transmits wavelength λ₂ and reflects wavelength λ₁. Typically, an optical filter (not shown) is positioned along the optical path to WFS 154, in order to attenuate light whose wavelength falls outside the band centered at wavelength λ₂.

The WFS determines the optical distortion due to atmospheric effects and sends correction signals 155a to an AWS controller 155 which controls the DM actuator 158. The AWS controller 155 has a closed-loop bandwidth of, for example, ten kilohertz (kHz) or less. This is sufficiently low to be within the frequency response of the DM actuator 158, and yet sufficiently high to follow the phase fluctuations generated by atmospheric turbulence, which have characteristic time constants on the order of milliseconds.

The large-aperture collimator optic 145 directs the reference beam 125 towards the beam-splitter 152, which reflects a portion of the reference beam towards the DM 156. The DM impresses onto the reference beam the phase compensation required to correct the optical turbulence and then reflects the light into dichroic beam-splitter 190. The latter reflects the light towards the MCPD subsystem 170. Note that the DM-reflected reference beam, which enters the MCPD subsystem, includes phase shifts caused by the surface of the DM, containing the atmospheric turbulence correction measured by the WFS 154. The light power of the reference beam is relatively low, on the order of a few watts or less, and therefore, the DM does not need to handle high-power laser intensity. The DM may be implemented, for example, by a micro-electromechanical system (MEMS) device such as the model “Multi-3.5-DM” available from Boston Micromachines Corp.

The collimated sub-beams 115 are partially reflected and partially transmitted by the dichroic beam-splitter 190. The surface 190a of the dichroic beam-splitter 190 typically has a reflectivity of at least 99.9% for optical wavelengths in the band centered at wavelength λ₁. The major portion of the optical energy in the CBC sub-beams 115 is reflected by surface 190a of the dichroic beam-splitter 190. This energy is steered by beam director 160 to illuminate a target 210. A small portion of the optical energy in the CBC sub-beams, typically 0.1% or less, is transmitted directly through surface 190a towards the MCPD subsystem 170. This portion of the CBC sub-beams, which does not reach the target 210, carries information pertaining to relative phase shifts between the sub-beams, which may be caused, for example, by high-frequency laser noise fluctuations in the CBC subsystem 110. The magnitude of the wavelength difference, |λ₂-λ₁|, is designed to be large enough to enable efficient splitting by the dichroic surface 190a.

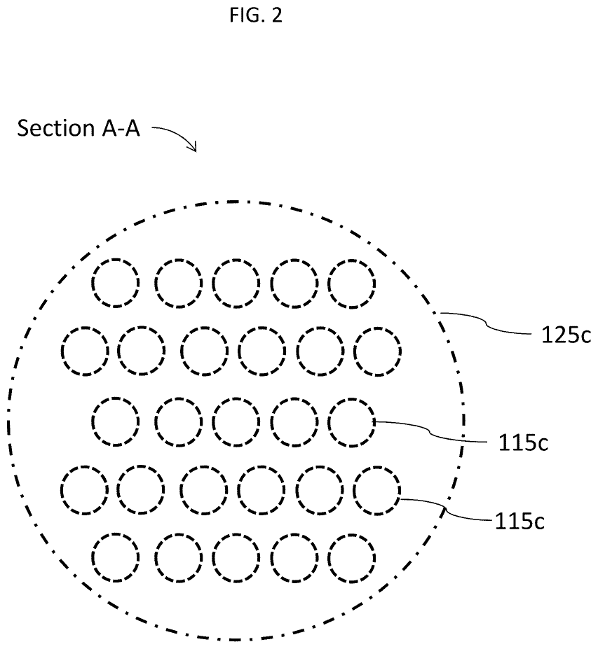

FIG. 2 shows a cross-sectional view of the overlap between the OPA reference beam and each of the CBS sub-beams, as they enter MCPD subsystem 170. The boundary 125c of the reference beam cross-section is large enough to enclose all of the sub-beam boundaries 115c. In this way, the electromagnetic fields of each of the CBC sub-beams 115 interfere with those of the OPA reference beam 125 at an incident surface of the MCPD subsystem.

All of the beams in FIG. 2 have wavelengths in the band centered around M. In one exemplary embodiment, the dichroic beam-splitter 190 is configured to have a reflection to transmission ratio similar in value to the ratio in intensity between the main and reference beam. For example, the main beam has 1000 times more power than the reference beam and the transmission of the dichroic beam-splitter 190 is 0.1%. In this way, the transmitted part of the reference beam is similar in intensity to the reflected part of the reference beam.

Returning to FIG. 1, the light entering MCPD subsystem 170 contains the DM-reflected reference beam 125 and a portion of the CBC sub-beams 115. Optical interference between the beams enables a fast MCPD 174 to determine the optical phases of the CBC sub-beams relative to the reference beam. Phase fluctuations caused by laser noise, for example, have frequencies in a range between 100 Hz and 10000 Hz. The fast MCPD 174 may implemented using a fast CMOS camera or a photodiode array having at least one pixel for each of the CBC sub-beams.

The MCPD pixel signals are used to calculate the phase difference between individual sub-beams and the reference beam. To remove the ambiguity in intensity-to-phase conversion, the phase of the reference beam may be modulated, leading to modulation of the light intensity in each pixel of the fast MCPD 174. With a sufficiently high dynamic range detector, the interference signal can be measured even if the intensity ratio between the main and the reference beams is as large as 10,000.

The MCPD output signals 175a are sent to the MCPD controller 175, which operates in a closed-loop with CBC sub-beam phase compensator 130. Note that the output from the MCPD controller 175 is used simultaneously to compensate the high-frequency laser noise and to copy the wavefront correction of the atmospheric turbulence from the reference beam into the CBC beam.

The frequency of the MCPD controller 175 is typically at least an order of magnitude greater than the bandwidth of the AWS controller 155, and at least order of magnitude higher than laser phase noise, thereby avoiding unwanted resonances or control instabilities between the two controllers.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. An optical phased array (OPA) system for illuminating a target in the presence of atmospheric turbulence, the system comprising:
a coherent beam combining (CBC) subsystem forming a multiplicity of at least partially coherent CBC sub-beams and a reference beam, said CBC sub-beams and said reference beam having a first band of optical wavelengths;
a beam director for directing the CBC sub-beams to illuminate the target;
an auxiliary light source to illuminate the target with light having a second band of optical wavelengths;
a receiving optical aperture configured to receive a portion of light reflected from the target in said first and second bands of optical wavelengths;
an atmospheric wave-front sensor (AWS) subsystem optically coupled to the receiving aperture and to the reference beam; and
a multi-channel photo-detector (MCPD) subsystem optically coupled to the CBC sub-beams and to the reference beam;
wherein,
the AWS subsystem comprises a closed-loop AWS controller for providing atmospheric turbulence compensation, and the MCPD subsystem comprises a closed-loop MCPD controller for compensating phase noise effects in the CBC sub-beams and for transferring the atmospheric turbulence compensation from the reference beam into the CBC beam.

2. The system of claim 1 wherein a frequency of the MCPD controller is at least an order of magnitude greater than a bandwidth of the AWS controller.

3. The system of claim 1 further comprising a CBC sub-beam phase compensator which is in communication with the MCPD controller.

4. The system of claim 1 wherein the MCPD subsystem comprises an array of photo-detectors having at least one pixel for each of the CBC sub-beams.

5. The system of claim 1 wherein a bandwidth of the AWS controller is less than or equal to ten kilohertz.

6. The system of claim 1 wherein said reference beam is collimated.

7. The system of claim 1 wherein the reference beam overlaps with all of the CBC sub-beams at an incident surface of the MCPD subsystem.

8. The system of claim 1 wherein the reference beam undergoes a phase modulation which is different from that of the CBC sub-beams.

9. The system of claim 1 wherein the AWS subsystem comprises a deformable mirror (DM) and a DM actuator.

10. The system of claim 9 wherein a surface of the DM is segmented or continuous.

11. The system of claim 1 wherein the AWS subsystem comprises a Shack-Hartmann sensor.

12. The system of claim 1 wherein the AWS subsystem comprises a pyramid detector or a phase diversity sensor.

13. The system of claim 1 wherein the AWS subsystem comprises an optical filter which attenuates light passing through the receiving optical aperture whose wavelength is outside the second band of optical wavelengths.

14. The system of claim 1 comprising a dichroic beam-splitter.

15. The system of claim 1 wherein the auxiliary light source is a laser.

16. The system of claim 1 wherein the auxiliary light source is a solar spectrum of the Sun.
